(19) United States
(12) Patent Application Publication
(10) Pub. No.: US 2025/0287132 A1
(43) Pub. Date: Sep. 11, 2025

(54) EARPHONES

(71) Applicant: SHENZHEN SHOKZ CO., LTD., Shenzhen (CN)

(72) Inventors: Guangyuan ZHU, Shenzhen (CN); Lei ZHANG, Shenzhen (CN); Zhao XIE, Shenzhen (CN); Xin QI, Shenzhen (CN)

(73) Assignee: SHENZHEN SHOKZ CO., LTD., Shenzhen (CN)

(21) Appl. No.: 19/218,349

(22) Filed: May 25, 2025

Related U.S. Application Data
(63) Continuation of application No. PCT/CN2023/126025, filed on Oct. 23, 2023.

(51) Int. Cl. H04R 1/10

(52) U.S. Cl. CPC H04R 1/105; H04R 1/1091; H04R 2460/13

(57) ABSTRACT

The present disclosure provides an earphone, comprising a housing component, a loudspeaker, and a protective net. The housing component is provided with an accommodation cavity and a pressure relief hole. The pressure relief hole is configured to connect the accommodation cavity with an external environment. An opening of the pressure relief hole is disposed at a bottom of the housing component along a height direction. The loudspeaker is disposed in the accommodation cavity. The protective net is connected to the housing component to cover the opening of the pressure relief hole. When projected along the height direction, a length of a projection of the protective net is more than 0.4 times a length of a projection of the housing component.

### CROSS-REFERENCE TO RELATED APPLICATIONS

This present disclosure is a continuation of International Patent Application No. PCT/CN2023/126025, filed on Oct. 23, 2023, the contents of which are hereby incorporated by reference.

### TECHNICAL FIELD

The present disclosure relates to the technical field of sound production instruments, and in particular to an earphone.

### BACKGROUND

Earphones have been widely used in people's daily lives as they can be used with electronic devices (e.g., a mobile phone, a computer, etc.) to provide an auditory feast to users. Currently, the air conduction principle has been extensively applied in the earphones. The earphone utilizing air conduction is renowned for its high-quality sound output, making it highly popular among users. Typically, existing protection solutions for a pressure relief hole in an air conduction loudspeaker are relatively rudimentary. The pressure relief hole, as a functional hole connecting the external environment and the air conduction loudspeaker, directly affects the sound quality of the air conduction loudspeaker in terms of the stability of its pressure relief performance. Due to the simplistic structural design of current earphones regarding the protection of the pressure relief hole of the air conduction loudspeaker, extreme cases such as clogging of the pressure relief hole or damage to the air conduction loudspeaker frequently occur, which greatly affects the practical experience of the users.

### SUMMARY

One or more embodiments of the present disclosure provide an earphone. The earphone may comprise: a housing component, a loudspeaker, and a protective net. The housing component may be provided with an accommodation cavity and a pressure relief hole, the pressure relief hole being configured to connect the accommodation cavity with an external environment. An opening of the pressure relief hole may be disposed at a bottom of the housing component along a height direction. The loudspeaker may be disposed in the accommodation cavity. The protective net may be connected to the housing component to cover the opening of the pressure relief hole. When projected along the height direction, a length of a projection of the protective net may be more than 0.4 times a length of a projection of the housing component.

In some embodiments, the protective net may include a first portion and a second portion, the first portion is low in the height direction relative to the second portion, and the second portion extends away from the first portion. As the second portion gradually extends away from the first portion, the second portion may be gradually higher than the first portion along the height direction.

In some embodiments, an area of the protective net may be more than 1.5 times an area of the opening.

In some embodiments, the housing component is equipped with a first concave portion, which is connected to the pressure relief hole, and the protective net also covers the opening of the first concave portion.

In some embodiments, the first concave portion may extend away from the pressure relief hole. As the first concave portion gradually extends away from the pressure relief hole, the first concave portion may be gradually higher than the opening of the pressure relief hole along the height direction.

In some embodiments, the protective net may include a first portion and a second portion, the first portion is low in the height direction relative to the second portion, and the second portion extends away from the first portion. As the second portion gradually extends away from the first portion, the second portion may be gradually higher than the first portion along the height direction, and the second portion may cover at least a portion of the opening of the first concave portion.

In some embodiments, the housing component may include a support member.

The support member may be configured to separate the opening of the pressure relief hole from the opening of the first concave portion, and the support member may support the protective net.

In some embodiments, the housing component may be provided with a sound receiving hole. The sound receiving hole may be arranged adjacent to the opening of the pressure relief hole. The protective net also may cover the sound receiving hole.

In some embodiments, an opening of the sound receiving hole may be higher than the opening of the pressure relief hole.

In some embodiments, the protective net may include a first portion and a second portion, the first portion is low in the height direction relative to the second portion, and the second portion extends away from the first portion. As the second portion gradually extends away from the first portion, the second portion may be gradually higher than the first portion along the height direction, and the second portion may cover the opening of the sound receiving hole.

In some embodiments, the sound receiving hole may be formed on a support wall, and the protective net may be attached to the support wall.

In some embodiments, the housing component may be provided with a second concave portion, and the protective net may be arranged in the second concave portion.

In some embodiments, the protective net may include a steel net, a gauze net, and a waterproof membrane. The gauze net may be provided on a side of the steel net facing the opening of the pressure relief hole, and the waterproof membrane may be provided on a side of the gauze net facing the opening of the pressure relief hole.

In some embodiments, each of net holes of the steel net may be less than each of net holes of the gauze net.

One or more embodiments of the present disclosure provide an earphone. The earphone may comprise a housing component, a loudspeaker, and a first annular protrusion. The housing component may be provided with an accommodation cavity and a pressure relief hole, the pressure relief hole being configured to connect the accommodation cavity with an external environment. An opening of the pressure relief hole may be disposed at a bottom of the housing component along a height direction. The loudspeaker may be disposed in the accommodation cavity. The first annular protrusion may be disposed around the opening of the pressure relief hole and extend downward from the bottom of the housing component.

In some embodiments, the first annular protrusion may be a metal ring or a plastic ring, and the first annular protrusion may be bonded to the bottom of the housing component.

In some embodiments, the first annular protrusion and a portion of the housing component may be an integrally molded structure.

In some embodiments, the earphone may further comprise a protective net configured to cover the opening of the pressure relief hole. In the height direction, the protective net may be higher than a bottom surface of the first annular protrusion.

In some embodiments, an inner side surface of the first annular protrusion may include an annular support surface, and the annular support surface may be connected with the protective net. In the height direction, a bottom surface of the protective net may be flush with the bottom surface of the first annular protrusion.

In some embodiments, the first annular protrusion may include a first portion and a second portion connected with the first portion. The first portion may be connected to the bottom of the housing component. A cross-sectional dimension of an internal channel of the first portion may be less than a cross-sectional dimension of an internal channel of the second portion. A transition between the first portion and the second portion may form the annular support surface.

In some embodiments, an annular groove may be provided on an outer edge of the annular support surface, and an adhesive may be provided in the annular groove.

In some embodiments, a protective net may include a steel net, a gauze net, and a waterproof membrane. The gauze net may be provided on a side of the steel net facing the opening of the pressure relief hole, and the waterproof membrane may be provided on a side of the gauze net facing the opening of the pressure relief hole.

In some embodiments, the accommodation cavity may include a first accommodation cavity and a second accommodation cavity isolated from each other. The loudspeaker may include a bone conduction loudspeaker and an air conduction loudspeaker. The bone conduction loudspeaker may be disposed in the first accommodation cavity, and the air conduction loudspeaker may be disposed in the second accommodation cavity.

In some embodiments, the opening of the pressure relief hole may extend toward a side where the first accommodation cavity is located. In some embodiments, the accommodation cavity may include a first accommodation cavity and a second accommodation cavity isolated from each other. The loudspeaker may include a bone conduction loudspeaker and an air conduction loudspeaker. The bone conduction loudspeaker may be disposed in the first accommodation cavity, and the air conduction loudspeaker may be disposed in the second accommodation cavity.

In some embodiments, the pressure relief hole may extend toward a side where the first accommodation cavity is located.

The beneficial effects of the present disclosure include the following content. According to the above setting, the protective net is connected to the housing component to cover the opening of the pressure relief hole, and when projected along the height direction, the length of the projection of the protective net is more than 0.4 times the length of the projection of the housing component. Accordingly, the overall size and area of the protective net are effectively increased, and the risk of clogging the pressure relief hole caused by sweat, rain, and other adverse external factors forming a water membrane on the protective net is reduced, thereby effectively ensuring the normal operation of pressure relief by the pressure relief hole, and effectively improving the stability of the sound production of the earphone.

### BRIEF DESCRIPTION OF THE DRAWINGS

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings.

FIG. 1 is a schematic structural diagram illustrating an overall assembly of an earphone according to some embodiments of the present disclosure;

FIG. 2 is a schematic diagram illustrating a local three-dimensional structure of a loudspeaker component and a wearing component in FIG. 1;

FIG. 3 is a schematic structural diagram illustrating an exploded view of a loudspeaker component in FIG. 2;

FIG. 4 is a schematic structural diagram illustrating an exploded view of an air conduction loudspeaker in FIG. 2;

FIG. 5 is a schematic structural diagram illustrating a cross-sectional view of an air conduction loudspeaker in FIG. 2;

FIG. 6 is a schematic diagram illustrating a three-dimensional structure of a magnetic conductive shield in FIG. 4;

FIG. 7 is a schematic diagram illustrating a three-dimensional structure of a magnetic conductive plate in FIG. 4;

FIG. 8 is a line chart illustrating a relationship between a weight variation of a loudspeaker component and a sensitivity variation of an air conduction loudspeaker caused by a preset ratio of a total area of weight reduction structure of a magnetic conductive shield to a total area of the magnetic conductive shield in FIG. 6;

FIG. 9 is a schematic diagram illustrating a three-dimensional structure of a magnet in FIG. 4;

FIG. 10 is a schematic diagram illustrating an exploded view of a first embodiment of a pressure relief hole protection solution of a loudspeaker component in FIG. 2;

FIG. 11 is a schematic structural diagram illustrating a portion after assembly of a first embodiment of a pressure relief hole protection solution of a loudspeaker component in FIG. 10;

FIG. 12 is a schematic diagram illustrating a three-dimensional structure of a protective net in FIG. 10;

FIG. 13 is a schematic diagram illustrating a front view of a second embodiment of a pressure relief hole protection solution of a loudspeaker component in FIG. 2;

FIG. 14 is a schematic structural diagram illustrating a cross-sectional view of a region A in FIG. 13 according to some embodiments of the present disclosure; and

FIG. 15 is a schematic structural diagram illustrating a cross-sectional view of a region A in FIG. 13 according to some other embodiments of the present disclosure.

### DETAILED DESCRIPTION

In order to make those skilled in the art better understand the technical solution of the present disclosure, the earphone provided by the present disclosure is further described in detail below with reference to the accompanying drawings and specific embodiments. It can be understood that the described embodiments are only part of the embodiments of the present disclosure, not all of the embodiments. Based on the embodiments of the present disclosure, all other embodiments obtained by those having ordinary skills in the art without making creative efforts are within the scope of protection of the present disclosure.

The terms “first,” “second,” etc. in the present disclosure are used to distinguish different objects instead of describing a specific order. In addition, the terms “including” and “having” and any of their variations are intended to cover non-exclusive inclusions. For example, a process, method, system, product, or device that includes a series of steps or units is not limited to the listed steps or units, but optionally includes steps or units that are not listed, or optionally includes other steps or units inherent to the process, method, product or device.

The present disclosure provides a wearable electronic device, including a core component. The wearable electronic device may include an earphone, glasses, an augmented reality (AR) device, a virtual reality (VR) device, etc. The following describes exemplary structures of the wearable electronic device through an actual application of the wearable electronic device of the present disclosure in an earphone.

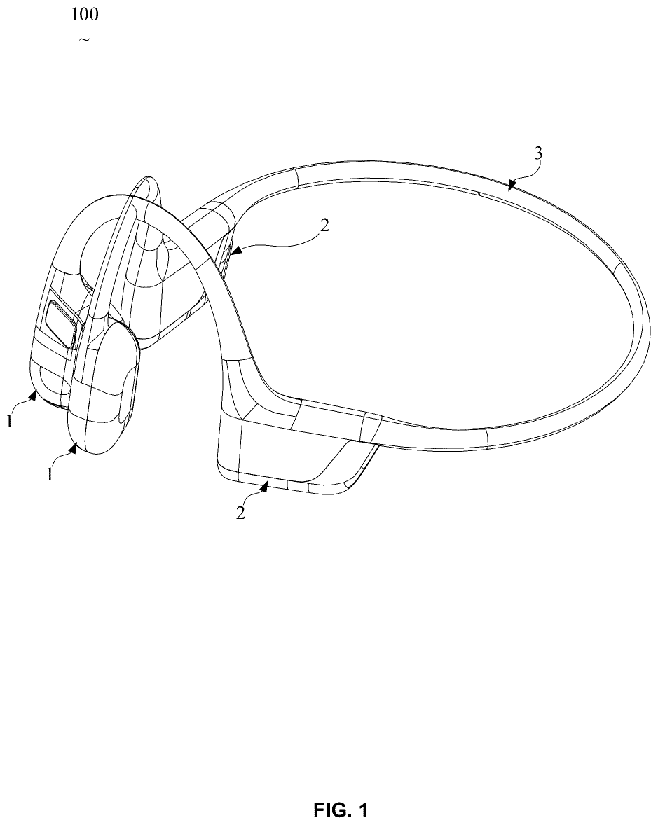

As shown in FIG. 1, an earphone 100 may include a loudspeaker component 1, an ear hook component 2, and a rear hook component 3. Two loudspeaker components 1 may be provided. The two loudspeaker components 1 may be configured to transmit vibration and/or sound to a left ear and a right ear of a user, respectively. The two loudspeaker components 1 may be the same or different. For example, one of the two loudspeaker components 1 may be provided with a microphone, while the other of the two loudspeaker components 1 may not be provided with the microphone. As another example, one of the two loudspeaker components 1 may be provided with a key and a corresponding circuit board, while the other of the two loudspeaker components 1 may not be provided with the key or the corresponding circuit board. The two loudspeaker components 1 may adopt the same configuration in terms of a core module (e.g., a loudspeaker module). The loudspeaker component 1 described in detail in the present disclosure may take one of the two loudspeaker components 1 as an example. Two ear hook components 2 may be provided, and the two ear hook components 2 may be respectively hung on the left ear and the right ear of the user, so that the loudspeaker components 1 can fit the face of the user. For example, one of the two ear hook components 2 may be provided with a battery, and the other of the two ear hook components 2 may be provided with a control circuit, etc. One end of one of the two ear hook components 2 may be connected with the loudspeaker component 1, and the other end of one of the two ear hook component 2 may be connected to the rear hook component 3. The rear hook component 3 may be configured to connect the two ear hook components 2, and wrap around a rear side of the neck or the head of the user to provide a clamping force, so that the two loudspeaker components 1 clamp two sides of the face of the user or are firmly disposed on outer sides of the ears of the user, and the ear hook components 2 are more firmly hung on the ears of the user. In some embodiments, the earphone 100 may not include the rear hook component 3, and the loudspeaker component 1 may be worn on the ears of the user through the ear hook components 2. In some embodiments, the earphone 100 may not include the ear hook components 2, and the loudspeaker component 1 may be connected through a head-mounted structure or a neck hanging structure by pressing the loudspeaker components 1 against the faces of the user or firmly setting the loudspeaker components 1 on the outer sides of the ears of the user.

The following mainly illustrates an exemplary description of the structure of the loudspeaker component 1, or the like, of the earphone 100. In some embodiments, the loudspeaker component 1 is also referred to as a core component.

Optionally, as shown in FIGS. 1-5, the loudspeaker component 1 may include a housing component 10, a bone conduction loudspeaker 11, and an air conduction loudspeaker 12.

The housing component 10 may be provided with a first accommodation cavity 1001 and a second accommodation cavity 1002. The bone conduction loudspeaker 11 may be disposed in the first accommodation cavity 1001, and the air conduction loudspeaker 12 may be disposed in the second accommodation cavity 1002. The air conduction loudspeaker 12 may include a magnetic circuit system 1260. The magnetic circuit system 1260 may include a magnet 1210 and a magnetic conductive component 1220. The magnet 1210 may be fixed on the magnetic conductive component 1220. The magnetic conductive component 1220 may be fixed in the second accommodation cavity 1002. A weight reduction structure 1223 may be provided on the magnetic conductive component 1220.

Specifically, in one embodiment, the bone conduction loudspeaker 11 and the air conduction loudspeaker 12 may be simultaneously disposed in the same housing component 10, and the bone conduction loudspeaker 11 may drive the loudspeaker component 1 to vibrate as a whole during operation to transmit a sound to the ears of the user. The air conduction loudspeaker 12 may include the magnetic circuit system 1260, and the magnetic circuit system 1260 may include the magnet 1210 and the magnetic conductive component 1220. Furthermore, the weight reduction structure 1223 may be disposed on the magnetic conductive component 1220. The weight reduction structure 1223 may be configured to reduce the overall weight of the air conduction loudspeaker 12, thereby effectively reducing the overall weight of the loudspeaker component 1, improving the user experience, and effectively improving the operation stability of the bone conduction loudspeaker 11. In addition, since the bone conduction loudspeaker 11 needs to drive the loudspeaker component 1 to vibrate as a whole during operation to transmit the sound to the ears of the user, reducing the overall weight of the loudspeaker component 1 can improve the operation sensitivity of the bone conduction loudspeaker 11, thereby effectively improving the sound transmission quality of the bone conduction loudspeaker 11, and effectively improving the sound quality of the earphone.

Optionally, the weight reduction structure 1223 may include at least one of a groove and a through hole provided on the magnetic conductive component 1220. In some embodiments, the through hole or the groove may be provided on the magnetic conductive component 1220 to serve as the weight reduction structure 1223 of the magnetic conductive component 1220, or the through hole and the groove may be provided simultaneously as the weight reduction structure 1223 of the magnetic conductive component 1220. For example, in one embodiment, the weight reduction structure 1223 is implemented by providing the through hole on the magnetic conductive component 1220, thereby effectively reducing the overall weight of the loudspeaker component 1.

Optionally, a magnetic induction intensity at a position where the weight reduction structure 1223 is provided on the magnetic conductive component 1220 may be less than a magnetic induction intensity at other positions. By providing the groove and/or the through hole at the position with a relatively small magnetic induction intensity on the magnetic conductive component 1220, the influence of providing the groove or the through hole on the magnetic conductive component 1220 on the magnetic conductivity function of the magnetic conductive component 1220 can be minimized, thereby ensuring that the overall weight of the loudspeaker component 1 is effectively reduced while minimizing the influence on the magnetic conductivity function of the magnetic conductive component 1220.

Optionally, the magnetic conductive component 1220 may include a magnetic conductive shield 1221 and a magnetic conductive plate 1222. The magnet 1210 may be fixed in the magnetic conductive shield 1221, and the magnetic conductive plate 1222 may be fixed on the magnet 1210. The weight reduction structure 1223 may be disposed on at least one of the magnetic conductive shield 1221 and the magnetic conductive plate 1222. One or more weight reduction structures 1223 may be provided on the magnetic conductive shield 1221 and the magnetic conductive plate 1222. When a plurality of weight reduction structures 1223 are used, the plurality of weight reduction structures 1223 may be arranged at intervals.

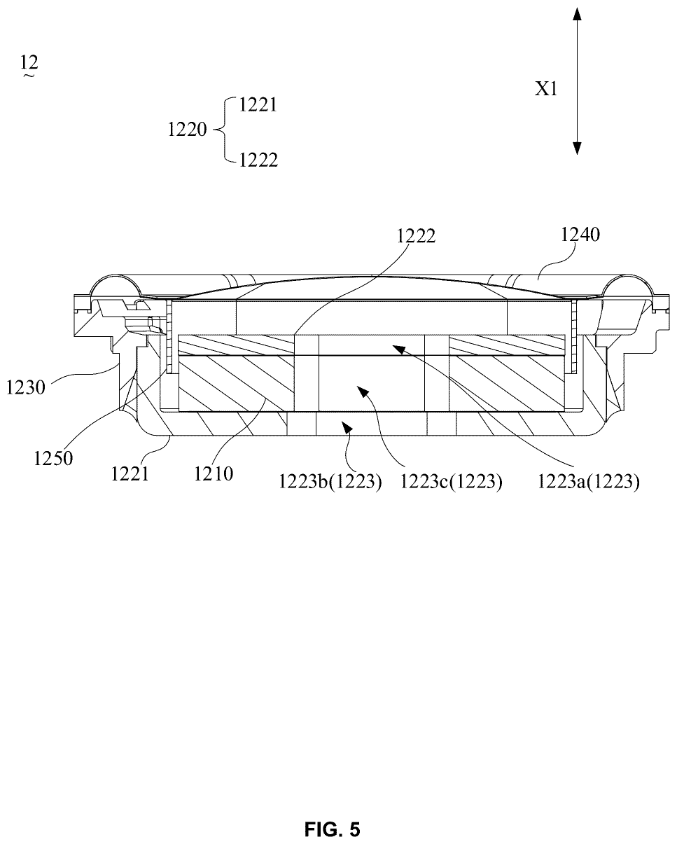

Specifically, the magnetic conductive shield 1221 may be provided with a magnet accommodation groove for accommodating and fixing the magnet 1210, the magnet 1210 may be fixed in the magnet accommodation groove, and the magnetic conductive plate 1222 may be fixed on a side of the magnet 1210 away from the magnet accommodation groove. For example, referring to FIG. 5, in one embodiment, the magnetic conductive shield 1221 and the magnetic conductive plate 1222 may be respectively provided with one or more weight reduction structures 1223 described in the above embodiments. In some embodiments, one or more weight reduction structures 1223 may be provided only on the magnetic conductive plate 1222 or the magnetic conductive shield 1221. For example, in one embodiment, one weight reduction structure 1223 may be provided on the magnetic conductive shield 1221, and one weight reduction structure 1223 may be correspondingly provided on the magnetic conductive plate 1222. Accordingly, the overall weight of the loudspeaker component 1 can be further reduced, thereby effectively improving the sound quality of the earphone.

Optionally, in one embodiment, the magnetic conductive shield 1221, the magnet 1210, and the magnetic conductive plate 1222 may be sequentially arranged in the center along an air conduction operation direction X1 of the air conduction loudspeaker 12. In this way, the center of gravity of the magnetic conductive component 1220 can be effectively guaranteed to be centered. The air conduction operation direction X1 is a vibration direction of a diaphragm of the air conduction loudspeaker 12 during operation.

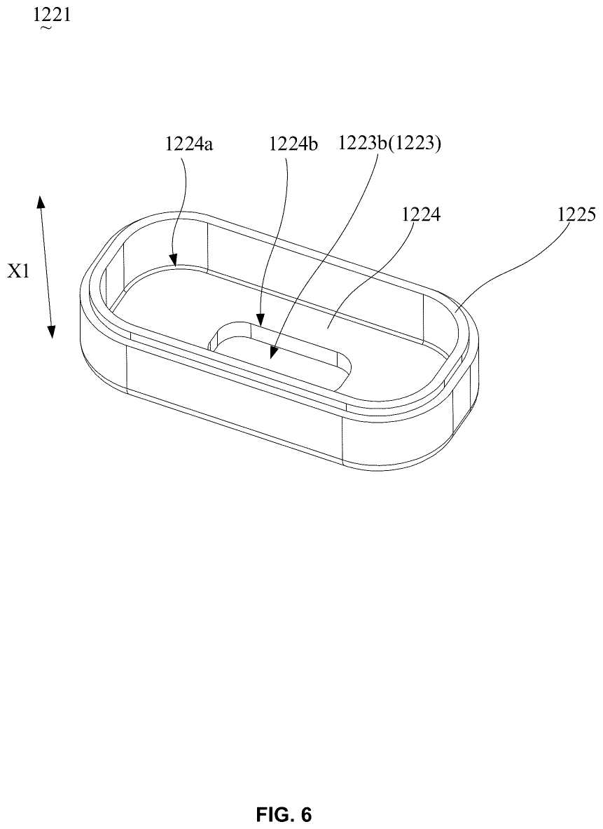

Optionally, as shown in FIG. 6, the magnetic conductive shield 1221 may include a bottom wall 1224 and an annular sidewall 1225 extending from the bottom wall 1224. A weight reduction structure 1223b may be provided on the bottom wall 1224. Specifically, referring to FIG. 6, in one embodiment, the magnetic conductive shield 1221 may include the bottom wall 1224 and the annular sidewall 1225 extending from the bottom wall 1224. The bottom wall 1224 and the annular sidewall 1225 may be enclosed to form the magnet accommodation groove described above. Furthermore, in one embodiment, the weight reduction structure 1223b may be provided on the bottom wall 1224. For example, a groove or a through hole may be provided on the bottom wall 1224. In this way, the material usage of the bottom wall 1224 can be effectively reduced, which effectively reduces the weight of the magnetic conductive shield 1221, and the weight of the air conduction loudspeaker 12, thereby effectively improving the operation stability of the bone conduction loudspeaker 11, and effectively improving the sound quality of the earphone.

Optionally, referring to FIG. 5 and FIG. 6, the weight reduction structure 1223b may be centrally provided on the bottom wall 1224. Specifically, the weight reduction structure 1223b on the magnetic conductive shield 1221 may be centrally provided on the bottom wall 1224 of the magnetic conductive shield 1221. A magnetic induction intensity at a center position of the bottom wall 1224 of the magnetic conductive shield 1221 may be less than a magnetic induction intensity at other positions. Accordingly, the weight reduction structure 1223b may be centrally provided on the bottom wall 1224, which can effectively reduce the influence of the weight reduction structure 1223b on the magnetic conductivity function of the magnetic conductive component 1220, and can effectively guarantee the center of gravity of the magnetic conductive shield 1221 to be centered, thereby effectively improving the operation stability of the bone conduction loudspeaker 11, and effectively improving the sound quality of the earphone.

It is understood that in some embodiments of the present disclosure, the weight reduction structure 1223b may also be provided at other positions on the bottom wall 1224 of the magnetic conductive shield 1221.

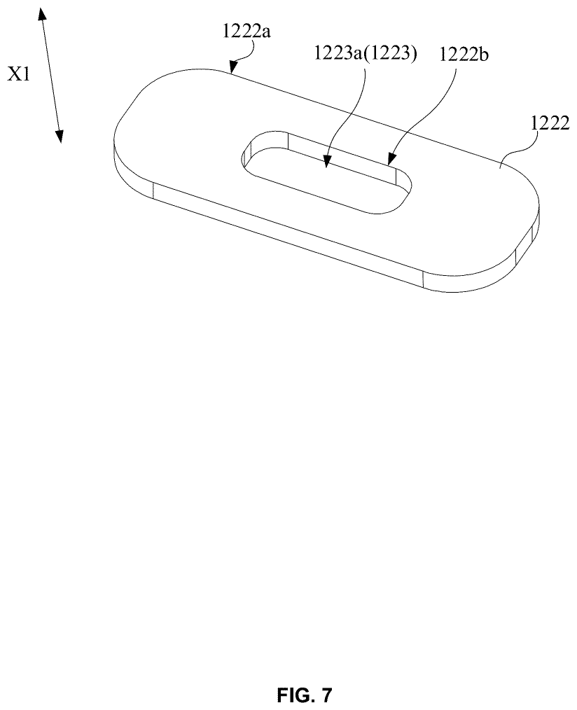

Optionally, referring to FIG. 5 and FIG. 7, a weight reduction structure 1223a may be centrally provided on the magnetic conductive plate 1222. Specifically, the weight reduction structure 1223a on the magnetic conductive plate 1222 may be centrally provided on the magnetic conductive plate 1222. The centers of gravity of parts of the air conduction loudspeaker 12, such as the magnetic conductive plate 1222, the magnetic conductive shield 1221, and the magnet 1210 are generally centrally arranged and located on the same straight line along the air conduction operation direction X1. In this way, it can be ensured that the center of gravity of the air conduction loudspeaker 12 is approximately located at the geometric center of the air conduction loudspeaker 12. The weight reduction structure 1223a being centrally arranged can effectively prevent shifting of the center of gravity of the air conduction loudspeaker 12 caused by shifting of the center of gravity of the weight reduction structure 1223a on the magnetic conductive plate 1222, thereby effectively improving the operation stability of the bone conduction loudspeaker 11, and effectively improving the sound quality of the earphone. Moreover, the magnetic induction intensity at the center position of the magnetic conductive plate 1222 may be less than the magnetic induction intensity at other positions. Accordingly, the weight reduction structure 1223a being centrally provided on the magnetic conductive plate 1222 can reduce the weight of the air conduction loudspeaker 12 while reducing the influence of the weight reduction structure 1223a on the magnetic conductivity function of the magnetic conductive component 1220.

Optionally, a ratio of a total area of the weight reduction structure on the magnetic conductive shield 1221 to an area of the bottom wall 1224 of the magnetic conductive shield 1221 may be less than or equal to a preset ratio. A ratio of a total area of the weight reduction structure on the magnetic conductive plate 1222 to an area of the magnetic conductive plate 1222 may be less than or equal to a preset ratio. Within the preset ratio, the magnetic induction intensity at the position where the weight reduction structure is located may be less than the magnetic induction intensity at other positions, thereby reducing the weight of the air conduction loudspeaker 12 while reducing the influence of the weight reduction structure 1223a on the magnetic conductive function of the magnetic conductive component 1220.

Specifically, referring to FIG. 5, FIG. 6, and FIG. 7, in one embodiment, the weight reduction structures may be respectively provided on the magnetic conductive plate 1222 and the magnetic conductive shield 1221. The area of the bottom wall 1224 of the magnetic conductive shield 1221 may be an area enclosed by an outer edge contour 1224a of the bottom wall 1224, and the total area of the weight reduction structure 1223b on the magnetic conductive shield 1221 may be a total area enclosed by the outer edge contour 1224a of the weight reduction structure 1223b. In one embodiment, the preset ratio may be 50%. In other words, the ratio of the total area of the weight reduction structure 1223b on the magnetic conductive shield 1221 to the area of the bottom wall 1224 of the magnetic conductive shield 1221 may be less than or equal to 50%. Accordingly, the weight of the magnetic conductive shield 1221 can be effectively reduced without affecting the magnetic conductivity function of the magnetic conductive shield 1221. Similarly, the area of the magnetic conductive plate 1222 may be an area enclosed by an outer edge contour 1222a of the magnetic conductive plate 1222, and the total area of the weight reduction structure 1223a on the magnetic conductive plate 1222 may be a total area enclosed by the outer edge contour 1222b of the weight reduction structure 1223a. The ratio of the total area of the weight reduction structure 1223a on the magnetic conductive plate 1222 to the area of the magnetic conductive plate 1222 may be less than or equal to 50%. Accordingly, the weight of the magnetic conductive plate 1222 can be effectively reduced without affecting the magnetic conductivity function of the magnetic conductive plate 1222. In some embodiments, if a plurality of weight reduction structures 1223b are provided on the magnetic conductive shield 1221, the total area of the plurality of weight reduction structures 1223b on the magnetic conductive shield 1221 may be a sum of areas of the plurality of weight reduction structures 1223b. Similarly, if a plurality of weight reduction structures 1223a are provided on the magnetic conductive plate 1222, the total area of the plurality of weight reduction structures on the magnetic conductive plate 1222 may be a sum of areas of the plurality of weight reduction structures 1223a.

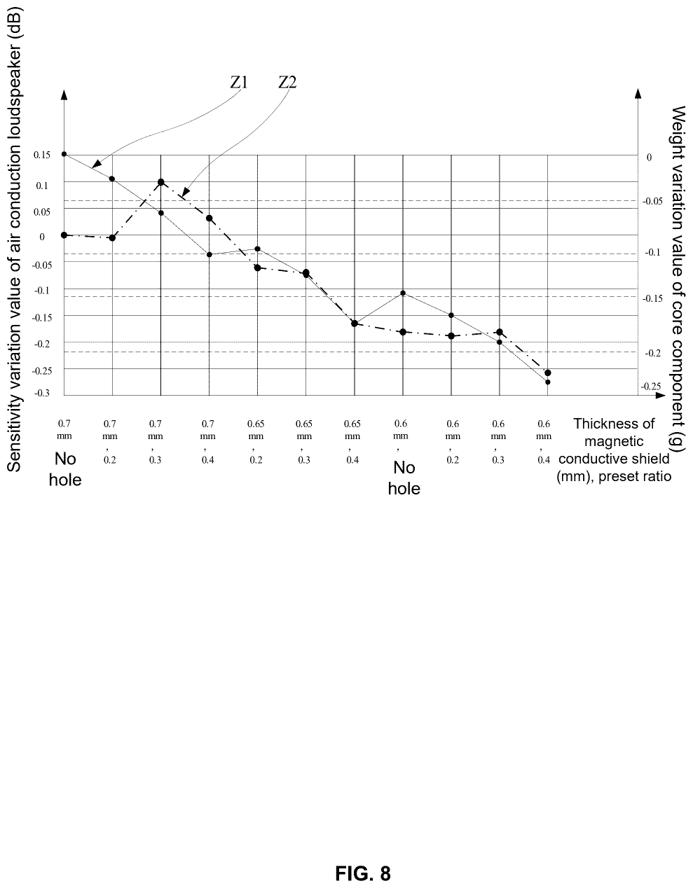

As shown in FIG. 8, a simulation experiment is conducted by taking the preset ratio of the total area of the weight reduction structure 1223b of the magnetic conductive shield 1221 to the total area of the bottom wall 1224 as an example, a relationship curve Z2 between the preset ratio and a sensitivity variation value of the air conduction loudspeaker 12 shown in FIG. 8 is obtained, and a relationship curve Z1 between the preset ratio and a weight variation value of the loudspeaker component 1 is obtained. Referring to the relationship curve Z1, the weight variation value of the loudspeaker component 1 increases as the preset ratio increases and the thickness of the bottom wall 1224 decreases. That is, the weight of the loudspeaker component 1 decreases as the preset ratio increases and the thickness of the bottom wall 1224 decreases. Referring to the relationship curve Z2, when the thickness of the bottom wall 1224 is the same, the sensitivity variation value of the air conduction loudspeaker 12 has a tendency to increase slightly and then decrease as the preset ratio increases. Accordingly, selecting a preset ratio less than or equal to 50% can effectively ensure the weight reduction effect of the loudspeaker component 1 while reducing the influence of the weight reduction structure 1223b on the magnetic conductivity function of the magnetic conductive shield 1221. In addition, it can be seen that under the same thickness of the bottom wall 1224, the preset ratio being less than or equal to 30% can make the loudspeaker component 1 obtain a better weight reduction effect under the premise of having a small influence on the magnetic conductivity function of the magnetic conductive shield 1221. The magnetic conductive plate 1222 can obtain the corresponding experimental data through a similar simulation experiment that when the preset ratio is less than or equal to 30%, the loudspeaker component 1 can obtain a better weight reduction effect under the premise of having a small influence on the magnetic conductivity function of the magnetic conductive plate 1222. The magnet 1210 also obtains a similar experiment result, which is not repeated in the present disclosure.

Optionally, in some embodiments, the preset ratio may be less than 50% and greater than 0, such as 45%, 40%, 35%, 28%, 20%, 10%, 5%, etc. In other words, the ratio of the total area of the weight reduction structure 1223b on the magnetic conductive shield 1221 to the area of the bottom wall 1224 of the magnetic conductive shield 1221 may be less than or equal to 50%. In this way, the weight of the magnetic conductive shield 1221 can be effectively reduced without affecting the magnetic conductivity function of the magnetic conductive shield 1221. The ratio of the total area of the weight reduction structure 1223a on the magnetic conductive plate 1222 to the area of the magnetic conductive plate 1222 may be less than 50%. In this way, the weight of the magnetic conductive plate 1222 can be effectively reduced without affecting the magnetic conductivity function of the magnetic conductive plate 1222.

In some embodiments, only one of the magnetic conductive plate 1222 and the magnetic conductive shield 1221 may be provided with the weight reduction structure 1223. The ratio of the total area of the weight reduction structure 1223 to the area of the magnetic conductive plate 1222 or the bottom wall 1224 of the magnetic conductive shield 1221 can be found in the present disclosure above, which is not repeated here.

Optionally, referring to FIG. 6, a plane shape of the weight reduction structure 1223b and a plane shape of the bottom wall 1224 of the magnetic conductive shield 1221 may be the same, and may be proportionally reduced. Specifically, the plane shape of the weight reduction structure 1223b and the plane shape of the bottom wall 1224 of the magnetic conductive shield 1221 being the same and being proportionally reduced means that a plane shape of the weight reduction structure 1223b on the magnetic conductive shield 1221 perpendicular to the air conduction operation direction X1 and a plane shape of the bottom wall of the magnetic conductive shield 1221 perpendicular to the air conduction operation direction X1 may be the same, and may be proportionally reduced. Accordingly, the center of gravity of the magnetic conductive shield 1221 can be effectively guaranteed to be centered. It is understood that in some embodiments of the present disclosure, the plane shape of the weight reduction structure 1223b on the magnetic conductive shield 1221 perpendicular to the air conduction operation direction X1 and the plane shape of the bottom wall of the magnetic conductive shield 1221 perpendicular to the air conduction operation direction X1 may be different.

Optionally, referring to FIG. 7, the plane shape of the weight reduction structure 1223a on the magnetic conductive plate 1222 perpendicular to the air conduction operation direction X1 and the plane shape of the magnetic conductive plate 1222 perpendicular to the air conduction operation direction X1 may be the same, and may be proportionally reduced. In this way, the center of gravity of the magnetic conductive plate 1222 can be effectively guaranteed to be centered. For example, in one embodiment, the weight reduction structure 1223b having the same plane shape as the magnetic conductive shield 1221 and proportionally reduced to the magnetic conductive shield 1221 may be centrally arranged on the magnetic conductive shield 1221, and the weight reduction structure 1223a having the same plane shape as the magnetic conductive plate 1222 and proportionally reduced to the magnetic conductive plate 1222 may be centrally arranged on the magnetic conductive plate 1222. In this way, the center of gravity of the air conduction loudspeaker 12 can be effectively guaranteed to be centered, and the weight of the loudspeaker component 1 can be effectively reduced, thereby effectively improving the sound quality of the earphone. It is understood that in some embodiments of the present disclosure, the plane shape of the weight reduction structure 1223a on the magnetic conductive plate 1222 perpendicular to the air conduction operation direction X1 may be different from the plane shape of the magnetic conductive plate 1222 perpendicular to the air conduction operation direction X1.

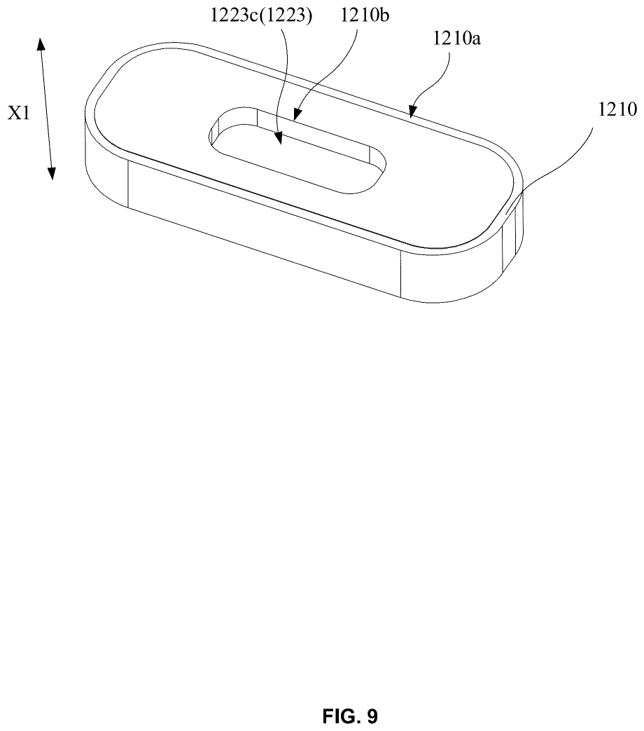

Optionally, referring to FIG. 5 and FIG. 9, a weight reduction structure 1223c may be provided on the magnet 1210, and the weight reduction structure 1223c may be a groove or a through hole. In one embodiment, the weight reduction structure 1223c may be the through hole. In this way, the weight of the loudspeaker component 1 can be further reduced, thereby effectively improving the sound quality of the earphone.

Optionally, a magnetic induction intensity at a position of the magnet 1210 where the weight reduction structure 1223c is located may be less than a magnetic induction intensity at other positions of the magnet 1210. Specifically, the magnetic induction intensity at the position where the weight reduction structure 1223c is located on the magnet 1210 may be less than the magnetic induction intensity at other positions. In this way, the overall weight of the loudspeaker component 1 can be effectively reduced without affecting the magnetic conductivity function of the magnetic conductive component 1220.

Optionally, referring to FIG. 5 and FIG. 9, the weight reduction structure 1223c on the magnet 1210 may be located at a center of the magnet 1210, and a plane shape of the weight reduction structure 1223c on the magnet 1210 may be the same as a plane shape of the magnet 1210 and may be proportionally reduced to the plane shape of the magnet 1210. Specifically, the plane shape of the weight reduction structure 1223c on the magnet 1210 and the plane shape of the magnet 1210 being the same and being proportionally reduced can be understood that the plane shape of the weight reduction structure 1223c on the magnet 1210 perpendicular to the air conduction operation direction X1 and the plane shape of the magnet 1210 perpendicular to the air conduction operation direction X1 may be the same and may be proportionally reduced. The weight reduction structure 1223c being arranged on the magnet 1210 in the above manner can effectively guarantee that the center of gravity of the air conduction loudspeaker 12 is centered while effectively reducing the weight of the loudspeaker component 1, thereby effectively improving the sound quality of the earphone.

Optionally, a ratio of a plane area of the weight reduction structure 1223c on the magnet 1210 to a plane area of the magnet 1210 may be less than a preset ratio. In one embodiment, the preset ratio may be 50%. In some embodiments, the preset ratio may be other values. The plane area of the weight reduction structure 1223c may be an area enclosed by an outer edge contour 1210b of the weight reduction structure 1223c, and the plane area of the magnet 1210 may be an area enclosed by an outer edge contour 1210a of the magnet. In this way, the weight of the magnet 1210 can be effectively reduced without affecting the magnetic conductivity function of the magnet 1210.

Optionally, the weight reduction structure 1223 does not need to be filled with other materials, such as a plastic part, i.e., the weight reduction structure 1223 remains in a hollow state. In this way, the weight reduction effect can be fully achieved.

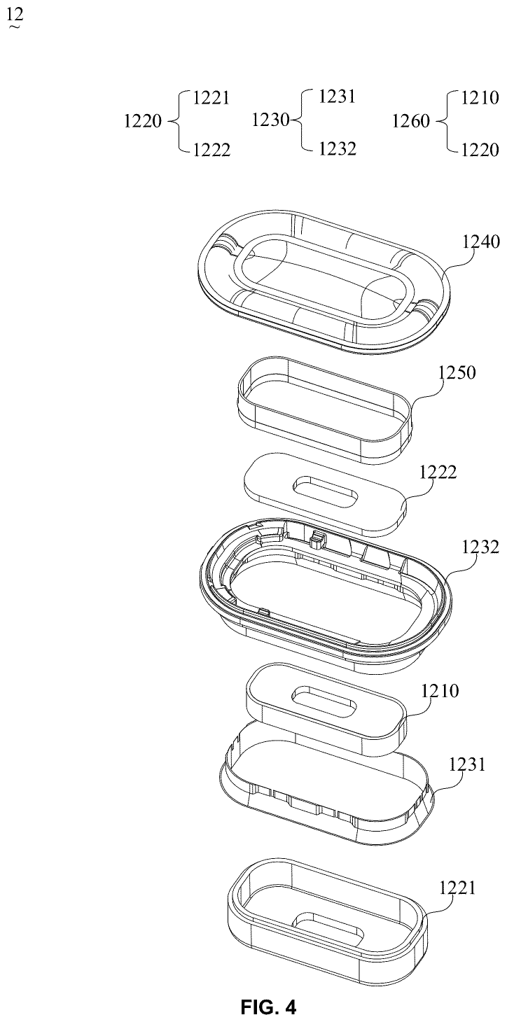

Optionally, referring to FIG. 4 and FIG. 5, the air conduction loudspeaker 12 may further include a holding component 1230. The holding component 1230 may be fixed to the magnetic conductive component 1220, and the holding component 1230 may be fixedly connected with the housing component 10. The magnetic conductive component 1220 provided with the magnet 1210 may be fixedly connected with the housing component 10 through the holding component 1230, so as to facilitate fixing the magnetic conductive component 1220 in the housing component 10, improve the connection stability between the magnetic conductive component 1220 and the housing component 10, reduce the shaking of the magnetic conductive component 1220 relative to the housing component 10, and effectively improve the operation stability of the air conduction loudspeaker 12, thereby effectively improving the sound quality of the earphone.

Optionally, referring to FIG. 4 and FIG. 5, the air conduction loudspeaker 12 may further include a diaphragm 1240 and a voice coil 1250. An edge of the diaphragm 1240 may be connected to a periphery of the holding component 1230, and the voice coil 1250 may be connected to the diaphragm 1240. Specifically, in one embodiment, the voice coil 1250 may be disposed around an outer periphery of the magnet 1210 and the magnetic conductive plate 1222, the edge of the diaphragm 1240 may be connected to the periphery of the holding component 1230, and the voice coil 1250 may be connected to the diaphragm 1240. For example, as shown in FIG. 4 and FIG. 5, in one embodiment, the holding component 1230 may include a holding ring 1231 and a holding body 1232. The holding ring 1231 may sleeve an outer peripheral side of the annular sidewall 1225 of the magnetic conductive shield 1221 and may be located between an inner sidewall of the holding body 1232 and the outer peripheral side of the annular sidewall 1225. Accordingly, the holding ring 1231 may be configured to provide a tension force. The edge of the diaphragm 1240 may be connected to the periphery of the holding body 1232. When the holding component 1230 and the magnetic conductive shield 1221 are assembled, the holding ring 1231 may directly sleeve the outer peripheral side of the annular sidewall 1225 of the magnetic conductive shield 1221, and then the magnetic conductive shield 1221 sleeved with the holding ring 1231 may be pushed into an inner peripheral side of the holding body 1232 along the air conduction operation direction X1, so that the magnetic conductive shield 1221 may be quickly fixed on the holding component 1230. In this way, the magnetic conductive shield 1221 and the holding body 1232 may maintain a stable fixed connection, and the assembly efficiency of the air conduction loudspeaker 12 may be effectively improved.

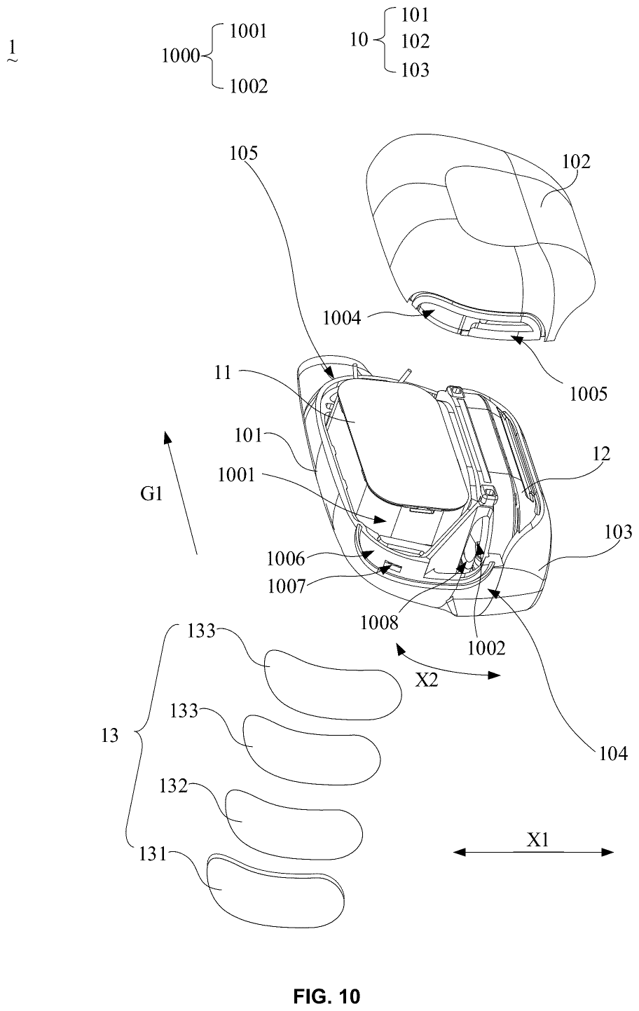

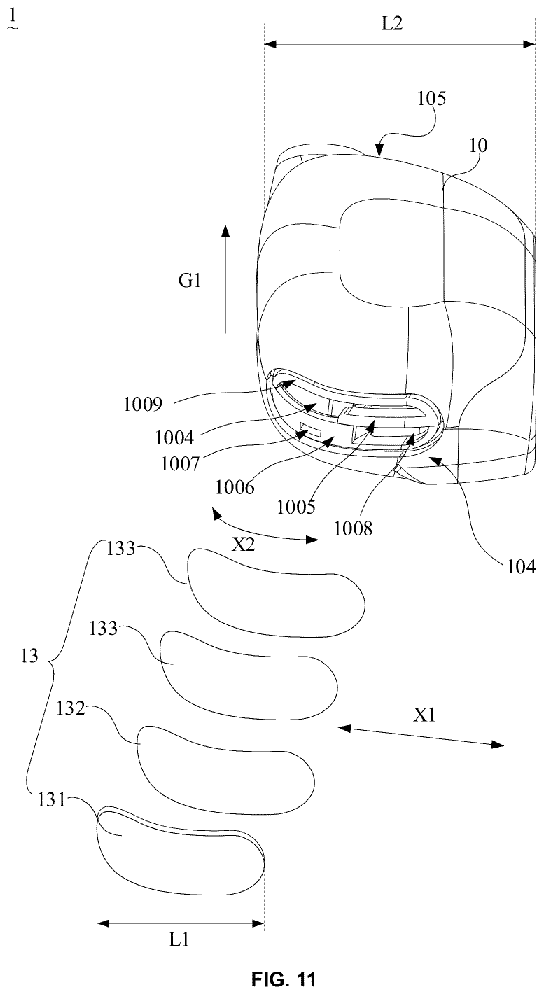

Optionally, referring to FIG. 10 and FIG. 11, the housing component 10 may be provided with a pressure relief hole 1008 configured to connect the second accommodation cavity 1002 with an external environment. The pressure relief hole 1008 may be configured to extend toward a side where the first accommodation cavity 1001 is located. The housing component 10 may be provided with the pressure relief hole 1008 for pressure relief of the air conduction loudspeaker 12. The pressure relief hole 1008 may be configured to connect the second accommodation cavity 1002 with the external environment, and the pressure relief hole 1008 may be configured to extend from a connection position with the second accommodation cavity 1002 toward the side where the first accommodation cavity 1001 is located. For example, a portion of a hole wall of the pressure relief hole 1008 may extend from the connection position with the second accommodation cavity 1002 toward the side where the first accommodation cavity 1001 is located. In this way, a space of the housing outside the first accommodation cavity 1001 occupied by the pressure relief hole 1008 can be effectively reduced, and a space between the first accommodation cavity 1001 and the second accommodation cavity 1002 can be effectively used to improve the space utilization rate of the housing component 10, so that the housing component 10 can be arranged more compactly and reasonably under the premise of satisfying a sound production condition of the air conduction loudspeaker 12. Moreover, such an inclined extension can increase the size of the pressure relief hole 1008, providing better sound quality for the air conduction loudspeaker 12.

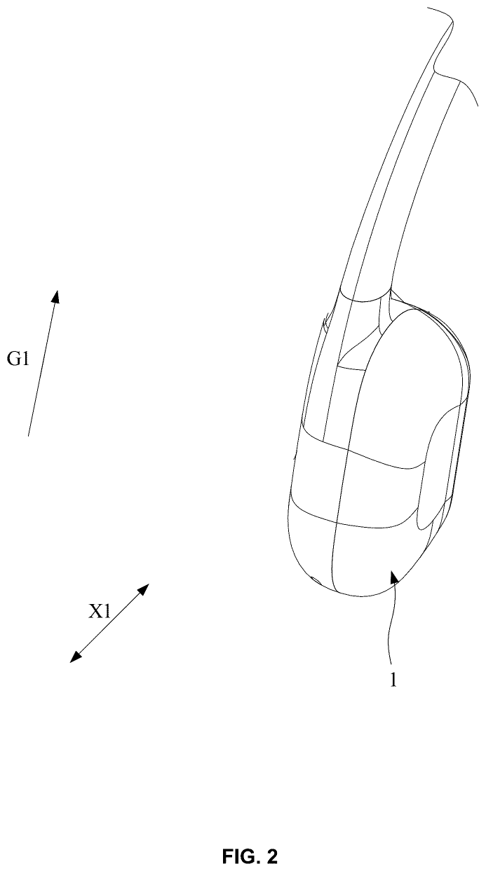

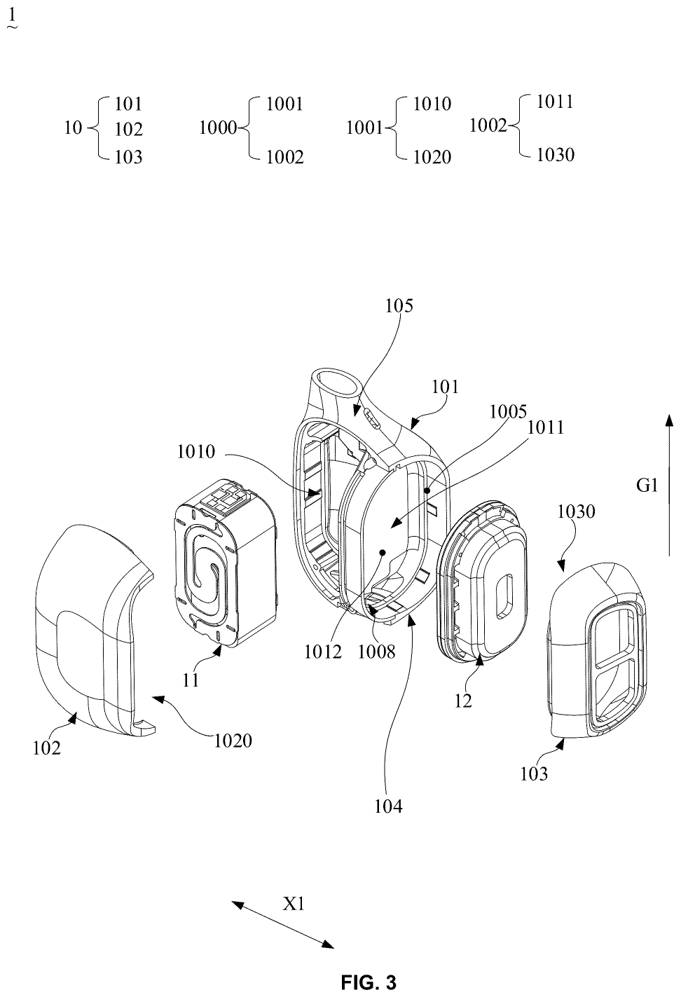

Optionally, referring to FIG. 2 and FIG. 3, the housing component 10 may include a shell 101, a shell 102, and a shell 103. The shell 101 and the shell 102 may cooperate with each other to form the first accommodation cavity 1001. The shell 101 and/or the shell 102 may further form a portion of the second accommodation cavity 1002, the shell 103 may form another portion of the second accommodation cavity 1002, and then the shell 103 may cooperate with the shell 101 and/or the shell 102 to form the second accommodation cavity 1002.

The housing component 10 may be composed of the shell 101, the shell 102, and the shell 103 by mutual cooperation. The shell 101 and the shell 102 may cooperate to form the first accommodation cavity 1001, and the shell 103 may cooperate with the shell 101 to form the second accommodation cavity 1002. The housing component 10 may be composed of the shell 101, the shell 102, and the shell 103 by mutual cooperation, which can make the structure of the loudspeaker component 1 compact and facilitate the assembly of the loudspeaker component 1, thereby improving the assembly efficiency of the loudspeaker component 1. In some embodiments, the shell 101 is referred to as a first shell, the shell 102 is referred to as a second shell, and the shell 103 is referred to as a third shell.

The housing component 10 may include the shell 101, the shell 102, and the shell 103. A partition wall 1012 may be disposed on the shell 101 and/or the shell 102, and the shell 101 and the shell 102 may cooperate with each other to form the first accommodation cavity 1001 and the pressure relief hole 1008. For example, the shell 101 and/or the shell 102 may further form a portion of the second accommodation cavity 1002. For example, the shell 103 may form another portion of the second accommodation cavity 1002, and the shell 103 may cooperate with the shell 101 and/or the shell 102 to form the second accommodation cavity 1002. Disposing the partition wall 1012 on the shell 101 and/or the shell 102 is understood as the partition wall 1012 being a portion of the shell 101 and/or the shell 102. The partition wall 1012 is not limited to being disposed on the shell 101 and/or the shell 102. In some embodiments, the partition wall 1012 may also be a component that is independent of the shell 101 and/or the shell 102.

As shown in FIG. 3, the partition wall 1012 may be disposed on the shell 101, and the shell 101 may be provided with a sub-accommodation cavity 1010 and a sub-accommodation cavity 1011, which are located on two opposite sides of the partition wall 1012. An opening direction of the sub-accommodation cavity 1010 is arranged along a wall surface of the partition wall 1012. Specifically, the opening direction of the sub-accommodation cavity 1010 may be parallel or substantially parallel to the wall surface of the partition wall 1012. The opening direction of the sub-accommodation cavity 1011 may intersect with the wall surface of the partition wall 1012. The shell 102 may be provided with a sub-accommodation cavity 1020, and the shell 102 may cover an opening end of the sub-accommodation cavity 1010. The sub-accommodation cavity 1020 may cooperate with the sub-accommodation cavity 1010 to form the first accommodation cavity 1001. The shell 103 may be provided with a sub-accommodation cavity 1030, and the shell 103 may cover an open end of the sub-accommodation cavity 1011. The sub-accommodation cavity 1030 may cooperate with the sub-accommodation cavity 1011 to form the second accommodation cavity 1002. In some embodiments, the sub-accommodation cavity 1010 is also referred to as a first sub-accommodation cavity, the sub-accommodation cavity 1011 is also referred to as a second sub-accommodation cavity, the sub-accommodation cavity 1020 is also referred to as a third sub-accommodation cavity, and the sub-accommodation cavity 1030 is also referred to as a fourth sub-accommodation cavity.

By setting the partition wall 1012, the shell 101 may be divided into the sub-accommodation cavity 1010 of which the opening direction is set along the wall surface of the partition wall 1012 and the sub-accommodation cavity 1012 of which the opening direction intersects the wall surface of the partition wall 1012, so that both the sub-accommodation cavity 1010 and the sub-accommodation cavity 1012 can achieve a relatively large space, thereby improving the space utilization rate of the shell 101 and reducing the mutual interference caused by vibrations of the bone conduction loudspeaker 11 and the air conduction loudspeaker 12 during operation, and improving the sound quality.

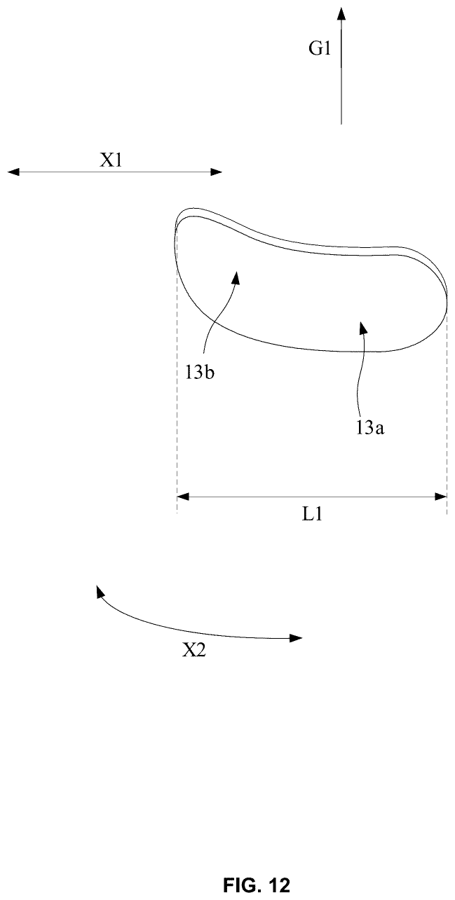

Optionally, as shown in FIG. 3, FIG. 10, FIG. 11, and FIG. 12, the present disclosure further provides a first embodiment of a pressure relief hole 1008 protection solution for protecting the pressure relief hole 1008. The first embodiment of the pressure relief hole 1008 protection solution is applicable to the earphone 100 provided with both the bone conduction loudspeaker 11 and the air conduction loudspeaker 12 as described above, and is also applicable to the earphone 100 provided with the air conduction loudspeaker 12 alone. The present disclosure mainly describes the first embodiment of the pressure relief hole 1008 protection solution by using the earphone 100 provided with both the air conduction loudspeaker 12 and the bone conduction loudspeaker 11 implemented in the above manner. The first embodiment of the pressure relief hole 1008 protection solution is as follows.

The loudspeaker component 1 may include a protective net 13. The housing component 10 may be provided with an accommodation cavity and the pressure relief hole 1008. The pressure relief hole 1008 is configured to connect the accommodation cavity with the external environment. An opening of the pressure relief hole 1008 may be located at a bottom 104 of the housing component 10 along a height direction G1. The loudspeaker may be disposed in the accommodation cavity. The protective net 13 may be connected to the housing component 10 to cover the opening of the pressure relief hole 1008. When projected along the height direction G1, a length L1 of a projection of the protective net 13 may be more than 0.4 times a length L2 of a projection of the housing component 10.

Specifically, as shown in FIG. 3 and FIG. 10, the accommodation cavity may be configured to accommodate the loudspeaker. As described above, the accommodation cavity may include the first accommodation cavity 1001 and the second accommodation cavity 1002 which are spaced apart from each other. The loudspeaker may include the air conduction loudspeaker 12 and the bone conduction loudspeaker 11. The air conduction loudspeaker 12 may be disposed in the second accommodation cavity 1002, and the bone conduction loudspeaker 11 may be disposed in the first accommodation cavity 1001. The specific structure of the housing component 10 is described above, which is not repeated here. In some embodiments, the accommodation cavity of the earphone 100 may only be provided with the air conduction loudspeaker 12, which is not repeated here.

As shown in FIG. 10 and FIG. 11, the housing component 10 may be provided with the pressure relief hole 1008 for pressure relief of the air conduction loudspeaker 12. The pressure relief hole 1008 may be configured to connect the accommodation cavity with the external environment, which can be understood as the pressure relief hole 1008 may be configured to connect the second accommodation cavity 1002 for accommodating the air conduction loudspeaker 12 with the external environment. Other relative positional relationships between the pressure relief hole 1008 and the accommodation cavity are described above, which are not repeated here.

Furthermore, the pressure relief hole 1008 may be located at the bottom 104 of the housing component 10 along the height direction G1, and when the earphone 100 is in a wearing state, the height direction G1 may be roughly parallel to a gravity direction. The bottom 104 of the housing component 10 may be located below in the height direction G1 or the gravity direction. In this way, the opening of the pressure relief hole 1008 may be located at the bottom 104 of the housing component 10 along the height direction G1, which can effectively prevent sweat, rain and other adverse external factors from entering the accommodation cavity along the opening of the pressure relief hole 1008 to damage the loudspeaker (i.e., the air conduction loudspeaker 12 in the present embodiment), thereby effectively improving the operation stability of the earphone 100. Furthermore, the earphone 100 may further include the protective net 13 for blocking the external adverse factors such as sweat, rain, and sand. The protective net 13 may be connected to the housing component 10 to cover the opening of the pressure relief hole 1008. When projected along the height direction G1, the length L1 of the projection of the protective net 13 may be more than 0.4 times the length L2 of the projection of the housing component 10. The projection length L1 may be a length of the protective net 13 along the air conduction operation direction X1. The length L1 of the projection of the protective net 13 may be 0.4-1 times the length L2 of the projection of the housing component 10, such as 0.4 times, 0.45 times, 0.5 times, 0.55 times, 0.6 times, 0.7 times, 0.8 times, 0.9 times, 1 time, etc. In this way, the overall area of the protective net 13 is effectively increased, and the risk of clogging the pressure relief hole 1008 caused by the sweat, rain and other external adverse factors forming a water membrane at the protective net 13 is reduced, thereby effectively ensuring that the pressure relief hole 1008 can perform normal operation of pressure relief, and effectively improving the stability of the sound production of the earphone 100. It is easy to understand that since the protective net 13 may be in a curved shape, an actual length of the protective net 13 may be greater than the length L1 of the projection of the protective net 13. The height direction G1 may be a direction from the bottom 104 of the housing component 10 to a top 105 of the housing component 10.

Optionally, as shown in FIG. 12, the protective net 13 may include a first portion 13a and a second portion 13b. The first portion 13a is low in the height direction G1 relative to the second portion 13b. The second portion 13b extends away from the first portion 13a. As the second portion 13b gradually extends away from the first portion 13a, the second portion 13b may be gradually higher than the first portion 13a along the height direction G1. In this way, the protective net 13 may be in a curved shape to be adapted to a shape of the housing component 10.

Specifically, the protective net 13 may include the first portion 13a and the second portion 13b. The first portion 13a is low in the height direction G1 relative to the second portion 13b. The second portion 13b extends away from the first portion 13a. As the second portion 13b gradually extends away from the first portion 13a, the second portion 13b may be gradually higher than the first portion 13a along the height direction G1. In this way, the protective net 13 may be in the curved shape, so that sweat, rainwater and other external adverse factors flowing through the second portion 13b eventually drip or slide directly to the first portion 13a and then drip, thereby effectively preventing the sweat, rainwater and other external adverse factors from accumulating in the second portion 13b to form a blockage. By setting the second portion 13b to be higher than the first portion 13a, which can effectively increase the kinetic energy of the sweat, rainwater and other external adverse factors, and effectively prevent the sweat, rainwater and other external adverse factors from accumulating on the protective net 13 to cause the blockage of the pressure relief hole 1008, or the like, thereby effectively improving the operation stability of the earphone 100.

Optionally, referring to FIG. 10 and FIG. 11, the housing component 10 may be provided with a first concave portion 1004. The first concave portion 1004 may be connected with the pressure relief hole 1008, and the protective net 13 may cover an opening of the first concave portion 1004. Specifically, the housing component 10 may be provided with the first concave portion 1004. The first concave portion 1004 may be connected with the pressure relief hole 1008. The air conduction operation direction X1 may be a vibration direction of the air conduction loudspeaker 12 during operation, and the air conduction operation direction X1 may be substantially perpendicular to the height direction G1. In this way, the first concave portion 1004 may be used as an auxiliary pressure relief hole of the air conduction loudspeaker 12, which can effectively increase a pressure relief area of the pressure relief hole. When the pressure relief hole 1008 is clogged, the air conduction loudspeaker 12 may continue to perform pressure relief through the first concave portion 1004, thereby effectively reducing the loss probability and degree of a low-frequency sound of the earphone 100, and effectively improving the operation stability of the earphone 100.

Optionally, the first concave portion 1004 may extend away from the pressure relief hole 1008. As the first concave portion 1004 gradually extends away from the pressure relief hole 1008, the first concave portion 1004 may be gradually higher than the opening of the pressure relief hole 1008 along the height direction G1. Specifically, the first concave portion 1004 may be located on a side of the pressure relief hole 1008 along an arrangement direction X2 which is parallel to the air conduction operation direction X1 and perpendicular to the height direction G1, and the first concave portion 1004 may extend away from the pressure relief hole 1008. As the first concave portion 1004 gradually extends away from the pressure relief hole 1008, the first concave portion 1004 may be gradually higher than the opening of the pressure relief hole 1008. In this way, the first concave portion 1004 can be effectively prevented from being clogged or immersed by the external factors such as sweat and rain, thereby effectively improving the operation stability of the air conduction loudspeaker 12.

Optionally, referring to FIG. 10, FIG. 11, and FIG. 12, the protective net 13 may include the first portion 13a and the second portion 13b. The first portion 13a is low in the height direction G1 relative to the second portion 13b. The second portion 13b extends away from the first portion 13a. As the second portion 13b gradually extends away from the first portion 13a, the second portion 13b may be gradually higher than the first portion 13a along the height direction G1. The second portion 13b may cover at least a portion of the opening of the first concave portion 1004. Specifically, the protective net 13 may be configured to be a curved shape in the above manner. The second portion 13b may cover at least a portion of the opening of the first concave portion 1004. For example, in one embodiment, the first portion 13a may cover a portion of the opening of the first concave portion 1004, and the second portion 13b may cover another portion of the opening of the first concave portion 1004. In this way, the first concave portion 1004 and the pressure relief hole 1008 may be completely covered by the protective net 13, which can effectively prevent the external factors such as sweat and rain from clogging the pressure relief hole 1008 and the first concave portion 1004, and effectively prevent other external granular adverse factors from entering the space of the second accommodation cavity along the pressure relief hole 1008 and the first concave portion 1004 to cause damage to the air conduction loudspeaker 12, thereby effectively improving the stability of the sound production of the earphone 100. The protective net 13 may be configured to be a curved shape based on the above manner, so that the sweat, rainwater and other external adverse factors flowing through the second portion 13b eventually drip or slide directly to the first portion 13a and then drip, thereby effectively preventing the sweat, rainwater and other external adverse factors from accumulating in the second portion 13b to form crystals. By setting the second portion 13b to be higher than the first portion 13a, the kinetic energy of the sweat, rainwater and other external adverse factors can be effectively increased, thereby effectively preventing the sweat, rainwater and other external adverse factors from accumulating on the protective net 13 to cause the blockage of the pressure relief hole 1008, or the like, thereby effectively improving the operation stability of the earphone 100.

Optionally, as shown in FIG. 10 and FIG. 11, the housing component 10 may include a support member 1005. The support member 1005 may be configured to separate the opening of the pressure relief hole 1008 from the opening of the first concave portion 1004, and the support member 1005 may be configured to support the protective net 13. Specifically, the support member 1005 may be disposed between the pressure relief hole 1008 and the first concave portion 1004, so as to abut against a central region of the protective net 13. In this way, the protective net 13 can be effectively prevented from collapsing due to an excessively large area, thereby ensuring that the protective net 13 can normally and stably perform the above functions, and effectively improving the operation stability of the earphone 100. Optionally, in some embodiments, the support member 1005 may be a structure integrated with the housing component 10. In some embodiments, the support member 1005 may be an independent component connected to the housing component 10 through a connector such as glue dispensing.

Optionally, as shown in FIG. 10 and FIG. 11, the housing component 10 may be provided with a sound receiving hole 1007. The sound receiving hole 1007 may be arranged adjacent to the opening of the pressure relief hole 1008, and the protective net 13 may cover the sound receiving hole 1007. Specifically, the sound receiving hole 1007 (e.g., voice of the user enters a microphone of the earphone 100 through the sound receiving hole 1007) of the earphone 100 for receiving sound information may be arranged adjacent to the pressure relief hole 1008, and the protective net 13 may cover the sound receiving hole 1007. The protective net 13 may effectively protect the sound receiving hole 1007 and prevent the sound receiving hole 1007 from being eroded by external adverse factors such as sweat and rain. When projected along the height direction G1, the length L1 of the projection of the protective net 13 may be more than 0.4 times the length L2 of the projection of the housing component 10. In this way, the length of the protective net 13 may be long enough, so that the sound receiving hole 1007 and the pressure relief hole 1008 may be staggered as much as possible in space, thereby effectively ensuring the sound quality of the earphone 100.

Optionally, as shown in FIG. 10 and FIG. 11, the opening of the sound receiving hole 1007 may be higher than the opening of the pressure relief hole 1008 along the height direction G1. Accordingly, the sound receiving hole 1007 may be arranged at a position higher than the bottom of the housing component 10 along the height direction G1, which can effectively prevent the sound receiving hole 1007 from being corroded by the external adverse factors such as sweat and rain.

Optionally, an area of the protective net 13 may be more than 1.5 times an area of the opening of the pressure relief hole 1008. For example, the area of the protective net 13 may be 1.5 times, 1.8 times, 2 times, 2.5 times, 3 times, 4 times, 5 times, 6 times, 7 times, 8 times, 9 times, 10 times, etc., the area of the opening of the pressure relief hole 1008. In this way, it is effectively ensured that the area of the protective net 13 is large enough, which reduces the risk of clogging the pressure relief hole 1008 caused by the sweat, rain and other external adverse factors forming the water membrane at the protective net 13, thereby effectively ensuring that the pressure relief hole 1008 can perform normal operation of pressure relief, and effectively improving the stability of the sound production of the earphone 100. In addition, the area of the protective net 13 can be set large enough relative to the pressure relief hole 1008, so that the first concave portion 1004, the sound receiving hole 1007, and the pressure relief hole 1008 can be protected more effectively together, thereby improving the protection efficiency. Meanwhile, a plurality of structures, such as the first concave portion 1004, the sound receiving hole 1007, and the pressure relief hole 1008 are placed together at the bottom 104 of the housing component 10, which can fully utilize the structural space of the housing component 10.

Optionally, as shown in FIG. 10 and FIG. 11, the protective net 13 may include the first portion 13a and the second portion 13b, the first portion 13a is low in the height direction G1 relative to the second portion 13b, the second portion 13b extends away from the first portion 13a; as the second portion 13b gradually extends away from the first portion 13a, the second portion 13b may be gradually higher than the first portion 13a along the height direction G1; and the second portion 13b may cover the opening of the sound receiving hole 1007. Specifically, the protective net 13 may be configured to be in a curved shape based on the above manner. The second portion 13b, which is higher than the first portion 13a, may cover the opening of the sound receiving hole 1007. For example, in one embodiment, the first portion 13a may cover a portion of the opening of the first concave portion 1004, and the second portion 13b may cover the opening of the sound receiving hole 1007 and another portion of the opening of the first concave portion 1004. In this way, the sound receiving hole 1007, the first concave portion 1004, and the pressure relief hole 1008 may be completely covered by the protective net 13, which can effectively prevent the external factors such as sweat and rain from clogging the sound receiving hole 1007, the pressure relief hole 1008, and the first concave portion 1004, and effectively prevent other external granular adverse factors from entering the space of the second accommodation cavity along the pressure relief hole 1008 and the first concave portion 1004 to cause damage to the air conduction loudspeaker 12, thereby effectively improving the stability of the sound production of the earphone 100.

Optionally, as shown in FIG. 10 and FIG. 11, the sound receiving hole 1007 may be formed on a support wall 1006, and the protective net 13 may be attached to the support wall 1006. Specifically, the support wall 1006 may serve as a portion of the housing component 10. The sound receiving hole 1007 may be formed on the support wall 1006, and the protective net 13 may be attached to the support wall 1006 to be supported by the support wall 1006, which effectively prevents the protective net 13 from collapsing under the action of an external force and affecting the normal operation of the earphone 100, thereby effectively improving the stability of the earphone 100. Optionally, the support wall 1006 may be formed by a portion of the bottom of the housing component 10 being recessed along the height direction G1. The first concave portion 1004 and the support wall 1006 may be located in different planes along the height direction G1. For example, the first concave portion 1004 may be higher than the support wall 1006 along the height direction G1. In this way, the sound receiving hole 1007 may be arranged at a position lower than the first concave portion 1004 along the height direction G1, which can effectively prevent the first concave portion 1004 from affecting the sound reception of the sound receiving hole 1007 when performing pressure relief.

Optionally, as shown in FIG. 9 and FIG. 10, the housing component 10 may be provided with a second concave portion 1009, and the protective net 13 may be disposed in the second concave portion 1009. Specifically, the second concave portion 1009 may be formed by integrally recessing a portion of a bottom region of the housing component 10 along the height direction G1, and may be configured to accommodate the protective net 13. An outer peripheral edge of the second concave portion 1009 may be further recessed along the height direction G1, so that an outer peripheral edge of the protective net 13 may abut against and be fixedly connected with the outer peripheral edge of the second concave portion 1009. For example, the fixed connection of the protective net 13 may be achieved by dispensing glue on the outer peripheral edge of the second concave portion 1009. The second concave portion 1009 may be configured to accommodate and fix the protective net 13, so that an outer surface of the protective net 13 and an outer surface of the housing component 10 are smoothly transitioned, thereby effectively improving the smooth shape of the outer contour of the earphone 100.

Optionally, as shown in FIG. 10 and FIG. 11, the protective net 13 may include a steel net 131, a gauze net 132, and a waterproof membrane 133. The gauze net 132 may be provided on a side of the steel net 131 facing the opening of the pressure relief hole 1008, and the waterproof membrane 133 may be provided on a side of the gauze net 132 facing the opening of the pressure relief hole 1008. Specifically, in one embodiment, the protective net 13 may include the steel net 131, the gauze net 132 and the waterproof membrane 133, and the gauze net 132 may be provided on the side of the steel net 131 facing the opening of the pressure relief hole 1008, i.e., a side of the steel net 131 close to the pressure relief hole 1008 (or a side of the steel net 131 close to the housing component 10). In this way, the gauze net 132 can effectively prevent external granular factors from entering the pressure relief hole 1008 to effectively protect the air conduction loudspeaker 12 from damage. In addition, the waterproof membrane 133 may be provided on the side of the gauze net 132 facing the opening of the pressure relief hole 1008, i.e., a side of the gauze net 132 close to the pressure relief hole 1008 (or a side of the gauze net 132 close to the housing component 10). In this way, the waterproof membrane 133 can effectively prevent sweat, rain and other external adverse factors from entering the second accommodation cavity 1002 along the pressure relief hole 1008, thereby effectively protecting the air conduction loudspeaker 12 and effectively improving the stability of the sound production of the earphone 100. Optionally, in one embodiment, at least two layers of waterproof membranes 133 may be provided on the side of the gauze net 132 facing the opening of the pressure relief hole 1008. In this way, the protective performance of the protective net 13 can be effectively improved.

Optionally, each of net holes of the steel net 131 may be less than each of net holes of the gauze net 132. In this way, the wind noise of the pressure relief hole 1008 can be effectively reduced, thereby effectively improving the sound quality of the earphone 100.

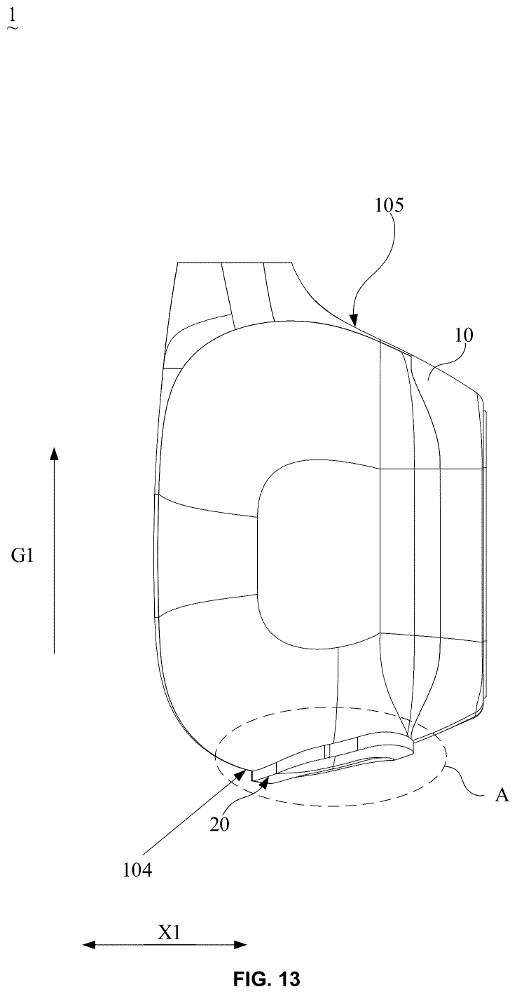

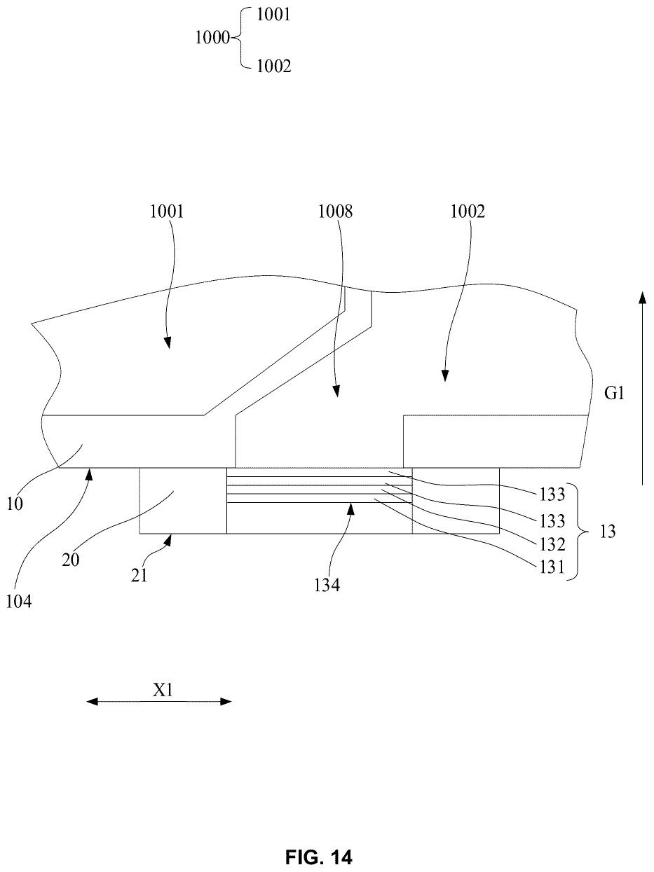

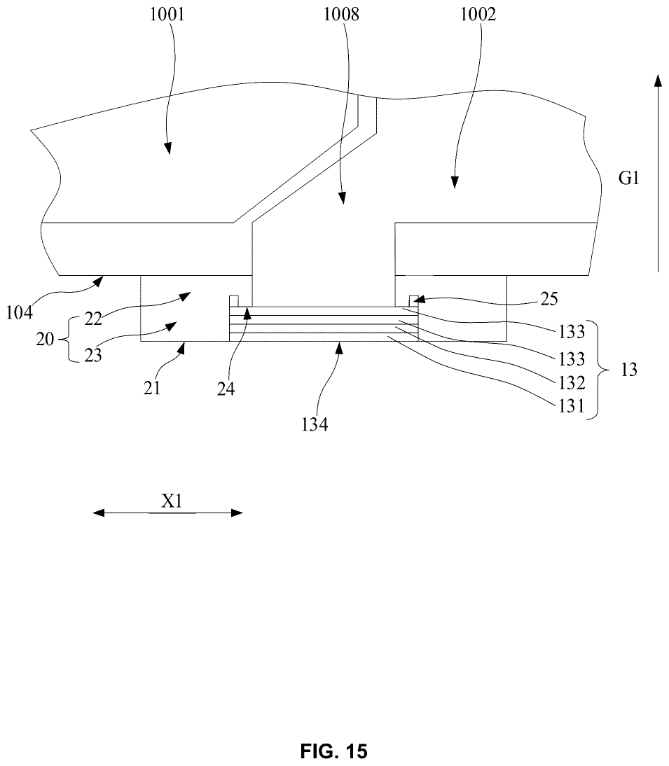

Optionally, as shown in FIG. 3, FIG. 13, FIG. 14, and FIG. 15, the present disclosure further provides a second embodiment of a pressure relief hole 1008 protection solution for protecting the pressure relief hole 1008. The second embodiment of the pressure relief hole 1008 protection solution is applicable to the earphone 100 provided with both the bone conduction loudspeaker and the air conduction loudspeaker 12 as described above, and is also applicable to the earphone 100 provided with the air conduction loudspeaker 12 alone. Here, the present disclosure mainly describes the second embodiment of the pressure relief hole 1008 protection solution by using the earphone 100 provided with both the air conduction loudspeaker 12 and the bone conduction loudspeaker implemented in the above manner. The second embodiment of the pressure relief hole 1008 protection solution is as follows.

The loudspeaker component 1 may include the housing component 10, a loudspeaker, and a first annular protrusion 20. The housing component 10 may be provided with an accommodation cavity. The housing component 10 may be provided with the pressure relief hole 1008 configured to connect the accommodation cavity with the external environment, and the opening of the pressure relief hole 1008 may be disposed at the bottom 104 of the housing component 10 along the height direction G1; the loudspeaker may be disposed in the accommodation cavity; the first annular protrusion 20 may be disposed around the opening of the pressure relief hole 1008, and may extend downward from the bottom 104 of the housing component 10.

Specifically, as shown in FIG. 3, the accommodation cavity may be configured to accommodate the loudspeaker. As described above, the accommodation cavity may include the first accommodation cavity 1001 and the second accommodation cavity 1002 which are spaced apart from each other. The loudspeaker may include the air conduction loudspeaker 12 and the bone conduction loudspeaker 11. The air conduction loudspeaker 12 may be disposed in the second accommodation cavity 1002, and the bone conduction loudspeaker 11 may be disposed in the first accommodation cavity 1001. The specific structure of the housing component 10 is described above, which is not repeated here. In some embodiments, the accommodation cavity of the earphone 100 may only be provided with the air conduction loudspeaker 12, which is not repeated here. In one embodiment, the pressure relief hole 1008 for pressure relief of the loudspeaker (e.g., the air conduction loudspeaker 12 in the above embodiment) may be provided on the housing component 10. The pressure relief hole 1008 may be configured to connect the accommodation cavity (e.g., the second accommodation cavity 1002 in the above embodiment) with the external environment. Other relative positional relationships between the pressure relief hole 1008 and the accommodation cavity may be found in the present disclosure above, which are not repeated here. Different from the above embodiments, in this embodiment, the loudspeaker component 1 may include the first annular protrusion 20. The first annular protrusion 20 may be disposed around an outer peripheral side of the opening of the pressure relief hole 1008 and may extend downward from the bottom 104 of the housing component 10. The first annular protrusion 20 extending downward from the bottom 104 of the housing component 10 can be understood as the first annular protrusion 20 protruding from the bottom surface of the housing component 10 along the height direction. In this way, the external environmental factors such as sweat and rain can be effectively prevented from flowing into the pressure relief hole 1008 to cause damage to the loudspeaker in the accommodation cavity, thereby effectively improving the stability of the sound production of the earphone 100. The height direction G1 is a direction from the bottom 104 of the housing component 10 to the top 105 of the housing component 10. Optionally, in some embodiments, the first annular protrusion 20 may be simultaneously disposed around the opening of the pressure relief hole 1008 and the outer peripheral side of the sound receiving hole 1007. In this way, the external environmental factors such as sweat and rain can be effectively prevented from flowing into the pressure relief hole 1008 and the sound receiving hole 1007 to cause damage to the loudspeaker in the accommodation cavity, thereby effectively improving the stability of the sound production of the earphone 100.

Optionally, the first annular protrusion 20 may be a metal ring or a plastic ring and bonded to the bottom 104 of the housing component 10. Specifically, in some embodiments, the first annular protrusion 20 may be a structural member, such as a metal ring or a plastic ring, which is fixedly connected to the housing component 10 through a connector, such as glue dispensing.

Optionally, the first annular protrusion 20 and a portion of the housing component 10 may be an integrally molded structure. Specifically, in some embodiments, a portion of the bottom of the housing component 10 located on the outer peripheral side of the opening of the pressure relief hole 1008 protrudes and deforms along the height direction toward a side away from the pressure relief hole 1008 to form the first annular protrusion 20, so as to form the integrally molded structure of the first annular protrusion 20 and the housing component 10. In the embodiment where the housing component 10 includes the shell 101, the shell 102, and the shell 103, the first annular protrusion 20 may be an integrally molded structure with the shell 101, or the first annular protrusion 20 may be an integrally molded structure with the shell 102; or, a portion of the first annular protrusion 20 may be an integrally molded structure with the shell 101, and another portion of the first annular protrusion 20 may be an integrally molded structure with the shell 102. Through the integrally molded structure, the manufacturing process of the first annular protrusion 20 can be simplified, the structural strength of the first annular protrusion 20 can be enhanced, and the manufacturing cost can be reduced.

Optionally, as shown in FIG. 14, the earphone 100 may include the protective net 13. The protective net 13 may cover the opening of the pressure relief hole 1008. In the height direction G1, the protective net 13 may be higher than a bottom surface 21 of the first annular protrusion 20. Specifically, the protective net 13 may be configured to cover the opening of the pressure relief hole 1008 to prevent the sweat, rain, and other external adverse factors from entering the pressure relief hole 1008. Furthermore, in some embodiments, the protective net 13 may be higher than the bottom surface 21 of the first annular protrusion 20 in the height direction G1, i.e., there is a height difference between a bottom surface 134 of the protective net 13 and the bottom surface 21 of the first annular protrusion 20, so that the protective net 13 is completely submerged in a region enclosed by the first annular protrusion 20, and the protective net 13 still has a certain height difference. Accordingly, the direct contact between the external environmental factors, such as rain and sweat, and the protective net 13 can be reduced to a certain extent, thereby reducing the possibility of the pressure relief hole 1008 being invaded by the external environmental factors such as rain and sweat.

Optionally, as shown in FIG. 15, in some embodiments, the earphone 100 may include the protective net 13, and an inner side surface of the first annular protrusion 20 may include an annular support surface 24. The annular support surface 24 may be connected with the protective net 13. In the height direction G1, the bottom surface 134 of the protective net 13 may be flush with the bottom surface 21 of the first annular protrusion 20. Specifically, in one embodiment, the first annular protrusion 20 may include a first portion 22 and a second portion 23 connected with the first portion 22 along the height direction G1. The first portion 22 may be connected to the bottom 104 of the housing component 10. A cross-sectional dimension of an internal channel of the first portion 22 may be less than a cross-sectional dimension of an internal channel of the second portion 23, and a transition position between the first portion 22 and the second portion 23 may form the annular support surface 24. The annular support surface 24 may protrude from the pressure relief hole 1008. The annular support surface 24 may be configured to support the protective net 13 and fixedly connected with the protective net 13. In this way, the bottom surface 134 of the protective net 13 may be flush with the bottom surface 21 of the first annular protrusion 20, i.e., the height difference between the bottom surface 134 of the protective net 13 and the bottom surface 21 of the first annular protrusion 20 is zero. Accordingly, the external factors such as sweat and rain can be effectively prevented from gathering in a space region between the bottom surface 134 of the protective net 13 and the bottom surface 21 of the first annular protrusion 20 to cause blockage of the pressure relief hole 1008, thereby effectively improving the operation stability of the earphone 100.

Optionally, as shown in FIG. 15, an annular groove 25 may be provided at an outer edge of the annular support surface 24, and an adhesive may be provided in the annular groove 25. Specifically, the outer edge of the annular support surface 24 is a position of the annular support surface 24 close to the second portion 23, and the annular support surface 24 may form the annular groove 25 at the position. The adhesive, such as glue dispensing, may be provided in the annular groove 25, and the protective net 13 may be connected to the annular support surface 24 through the adhesive, so as to be effectively and fixedly connected to the annular support surface 24.

Optionally, as shown in FIG. 14 and FIG. 15, the type of the protective net 13 may be similar to that of the above embodiments, i.e., the protective net 13 may include the steel net 131, the gauze net 132, and the waterproof membrane 133. The gauze net 132 may be provided on the side of the steel net 131 facing the opening of the pressure relief hole 1008, and the waterproof membrane 133 may be provided on the side of the gauze net 132 facing the opening of the pressure relief hole 1008. In other words, in one embodiment, the protective net 13 may include the steel net 131, the gauze 132, and the waterproof membrane 133. The gauze net 132 may be provided on the side of the steel net 131 facing the opening of the pressure relief hole 1008, i.e., the side of the steel net 131 close to the pressure relief hole 1008 (also referred to as the side of the steel net 131 close to the housing component 10). In this way, the gauze net 132 can effectively prevent the external granular factors from entering the pressure relief hole 1008, thereby effectively protecting the air conduction loudspeaker 12 from damage. In addition, the waterproof membrane 133 may be provided on the side of the gauze net 132 facing the opening of the pressure relief hole 1008, i.e., the side of the gauze net 132 close to the pressure relief hole 1008 (also referred to as the side of the gauze net 132 close to the housing component 10). In this way, the waterproof membrane 133 can effectively prevent the sweat, rain, and other external adverse factors from entering the second accommodation cavity 1002 along the pressure relief hole 1008, thereby effectively protecting the air conduction loudspeaker 12 and effectively improving the stability of the sound production of the earphone 100. Optionally, in one embodiment, at least two layers of waterproof membranes 133 may be provided on the side of the gauze net 132 facing the opening of the pressure relief hole 1008, so as to effectively improve the protective performance of the protective net 13.

Optionally, each of the net holes of the steel net 131 may be less than each of the net holes of the gauze net 132. Accordingly, the wind noise of the pressure relief hole 1008 can be effectively reduced, thereby effectively improving the sound quality of the earphone 100.

The above descriptions are only some embodiments of the present disclosure, and do not limit the protection scope of the present disclosure. Any equivalent device or equivalent process transformation made using the contents of the present specification and drawings, or directly or indirectly used in other related technical fields, are also included in the patent protection scope of the present disclosure.

What is claimed is:

1. An earphone, comprising:
a housing component provided with an accommodation cavity and a pressure relief hole, the pressure relief hole being configured to connect the accommodation cavity with an external environment, an opening of the pressure relief hole being disposed at a bottom of the housing component along a height direction;
a loudspeaker disposed in the accommodation cavity; and
a protective net connected to the housing component to cover the opening of the pressure relief hole, wherein when projected along the height direction, a length of a projection of the protective net is more than 0.4 times a length of a projection of the housing component.

2. The earphone of claim 1, wherein the protective net includes a first portion and a second portion, the first portion is low in the height direction relative to the second portion, the second portion extends away from the first portion, and as the second portion gradually extends away from the first portion, the second portion is gradually higher than the first portion along the height direction.

3. The earphone of claim 1, wherein an area of the protective net is more than 1.5 times an area of the opening.

4. The earphone of claim 1, wherein the housing component is provided with a first concave portion, the first concave portion is connected with the pressure relief hole, and the protective net covers an opening of the first concave portion.

5. The earphone of claim 4, wherein the first concave portion extends away from the pressure relief hole, and as the first concave portion gradually extends away from the pressure relief hole, the first concave portion is gradually higher than the opening of the pressure relief hole along the height direction.

6. The earphone of claim 5, wherein the protective net includes a first portion and a second portion, the first portion is low in the height direction relative to the second portion, and the second portion extends away from the first portion, wherein
as the second portion gradually extends away from the first portion, the second portion is gradually higher than the first portion along the height direction, and
the second portion covers at least a portion of the opening of the first concave portion.

7. The earphone of claim 4, wherein the housing component includes a support member configured to separate the opening of the pressure relief hole from the opening of the first concave portion, and the support member supports the protective net.

8. The earphone of claim 1, wherein the housing component is provided with a sound receiving hole, the sound receiving hole is arranged adjacent to the opening of the pressure relief hole, and the protective net covers the sound receiving hole.

9. The earphone of claim 8, wherein along the height direction, an opening of the sound receiving hole is higher than the opening of the pressure relief hole.

10. The earphone of claim 9, wherein the protective net includes a first portion and a second portion, the first portion is low in the height direction relative to the second portion, and the second portion extends away from the first portion, wherein
as the second portion gradually extends away from the first portion, the second portion is gradually higher than the first portion along the height direction, and
the second portion covers the opening of the sound receiving hole.

11. The earphone of claim 8, wherein the sound receiving hole is formed on a support wall, and the protective net is attached to the support wall.

12. The earphone of claim 1, wherein the housing component is provided with a second concave portion, and the protective net is arranged in the second concave portion.

13. The earphone of claim 1, wherein the protective net includes a steel net, a gauze net, and a waterproof membrane, the gauze net is provided on a side of the steel net facing the opening of the pressure relief hole, and the waterproof membrane is provided on a side of the gauze net facing the opening of the pressure relief hole.

14. The earphone of claim 13, wherein each of net holes of the steel net is less than each of net holes of the gauze net.

15. An earphone, comprising:
a housing component provided with an accommodation cavity and a pressure relief hole, the pressure relief hole being configured to connect the accommodation cavity with an external environment, an opening of the pressure relief hole being disposed at a bottom of the housing component along a height direction;
a loudspeaker disposed in the accommodation cavity; and
a first annular protrusion disposed around the opening of the pressure relief hole and extending downward from the bottom of the housing component, and
a protective net configured to cover the opening of the pressure relief hole, in the height direction, the protective net being higher than a bottom surface of the first annular protrusion.

16. The earphone of claim 15, wherein an inner side surface of the first annular protrusion includes an annular support surface, and the annular support surface is connected with the protective net, in the height direction, a bottom surface of the protective net being flush with the bottom surface of the first annular protrusion.

17. The earphone of claim 16, wherein the first annular protrusion includes a first portion and a second portion connected with the first portion, the first portion is connected to the bottom of the housing component;
a cross-sectional dimension of an internal channel of the first portion is less than a cross-sectional dimension of an internal channel of the second portion, and a transition between the first portion and the second portion forms the annular support surface.

18. The earphone of claim 17, wherein an annular groove is provided on an outer edge of the annular support surface, and an adhesive is provided in the annular groove.

19. The earphone of claim 15, wherein the accommodation cavity includes a first accommodation cavity and a second accommodation cavity isolated from each other, and
the loudspeaker includes a bone conduction loudspeaker and an air conduction loudspeaker, the bone conduction loudspeaker being disposed in the first accommodation cavity, and the air conduction loudspeaker being disposed in the second accommodation cavity.

20. The earphone of claim 19, wherein the opening of the pressure relief hole extends toward a side where the first accommodation cavity is located.
